(19) United States
(12) Patent Application Publication
(10) Pub. No.: US 2020/0050997 A1
(43) Pub. Date: Feb. 13, 2020

(54) SYSTEM AND METHOD FOR AUTOMATICALLY OPTIMIZING AND IMPLEMENTING A TRAVEL ITINERARY USING A MACHINE LEARNING MODEL

(71) Applicant: XSELIS, Inc., Cedar Park, TX (US)

(72) Inventors: Tyler Logan Fox, Cedar Park, TX (US); Kevin Tyler Gardenhire, Round Rock, TX (US)

(21) Appl. No.: 16/100,386

(22) Filed: Aug. 10, 2018

(51) Int. Cl. G06Q 10/06; G06Q 10/10; G06F 15/18; G06K 9/62; G06Q 50/14

(52) U.S. Cl. CPC G06Q 10/063112; G06Q 10/063116; G06Q 50/14; G06F 15/18; G06K 9/6256; G06Q 10/1095

(57) ABSTRACT

A method for automatically optimizing a travel itinerary and automatically implementing for the travel itinerary, using a machine learning model executed on a server, the method includes: obtaining a first set of data; generating a first database from the first set of data; determining, using the machine learning model, one or more travel options that are specific to a planned travel by analyzing the first set of data, wherein the machine learning model is generated by generating a second database with a first set of data associated with travellers, generating a third database with a travel itinerary of the travellers, processing an expert input on the travel itinerary of the travellers, and providing (a) the first set of data associated with the travellers, (b) the travel itinerary of the travellers, and (c) the expert input on the travel itinerary of the travellers, to a machine learning algorithm as training data; obtaining an itinerary plan request from a user; generating, using the machine learning model, a travel itinerary for the itinerary plan request for the user by analyzing the one or more travel options, and automatically implementing the travel itinerary by making arrangements for at least one of aircraft, hotel or ground transportation based on the one or more travel options.

### TECHNICAL FIELD

The present disclosure relates generally to a system and a method for automatically optimizing and implementing a travel itinerary using a machine learning model; moreover, the aforesaid system employs, when in operation, machine learning techniques for making arrangements (e.g. booking of tickets) for the travel itinerary.

### BACKGROUND

A travel itinerary is a schedule of events relating to planned travel, generally including destinations to be visited at specified times and means of transportation to move between those destinations.

Currently, businesses have very inefficient methods for planning and directing travel in a way that efficiently supports their activities and changing needs. Lack of efficient, data-driven scheduling prevents optimized utilization of the company's assets, limits workforce availability and causes missed opportunities. If a business wants to purchase and operate a business aircraft tickets today, there is currently no system or tool available for either accurately assessing, based on cost and time factors, which aircraft is best suited for their mission, or for managing that aircraft in conjunction with commercial air travel options for their unique company structure and goals. This results in significant time and money being wasted on inefficient commercial travel efforts or purchasing overpriced aircraft tickets that are not best suited to their mission. This all leads to missed opportunities, a significant potential loss of income and waste of resources. Further, travel plans may have to be changed due to changes in schedules, meetings etc. which may vary dynamically.

Therefore, in light of the foregoing discussion, there exists a need to overcome the aforementioned drawbacks in existing approaches for planning travel that can optimize resources and adapt to changing needs of user.

### SUMMARY

The present disclosure provides a method for automatically optimizing a travel itinerary and automatically implementing for the travel itinerary, using a machine learning model executed on a server, the method comprises:
obtaining a first set of data;
generating a first database from the first set of data;
determining, using the machine learning model, one or more travel options that are specific to a planned travel by analyzing the first set of data, wherein the machine learning model is generated by
   generating a second database with a first set of data associated with travellers,
   generating a third database with a travel itinerary of the travellers,
   processing an expert input on the travel itinerary of the travellers, and
   providing (a) the first set of data associated with the travellers, (b) the travel itinerary of the travellers, (c) the expert input on the travel itinerary of the travellers, to a machine learning algorithm as training data;
obtaining an itinerary plan request from a user;
generating, using the machine learning model, a travel itinerary for the itinerary plan request for the user by analyzing the one or more travel options, and automatically implementing the travel itinerary by making arrangements for at least one of aircraft, hotel or ground transportation based on the one or more travel options.

It will be appreciated that the aforesaid present method is not merely a “method of doing a mental act”, but has technical effect in that the method functions as a form of technical control using machine learning of a technical artificially intelligent system. The method involves building an artificially intelligent machine learning model and/or using the machine learning model to solve the technical problem of automatically optimizing a travel itinerary and automatically implementing the travel itinerary for making arrangements (e.g. booking tickets, reserving a seat etc.) for at least one of aircraft, hotel or ground transportation for the user's itinerary plan request by using the machine learning model.

Moreover, it will be appreciated that patent authorities (for example the UKIPO and the EPO) regularly grant patent rights for data encoders, wherein input data to the encoders is often of an abstract nature (for example computer generated graphics) and encoding merely amounts to rearranging bits present in the input data, namely merely causing a change in data entropy (see for example, MPEG encoders, JPEG encoders, H. 264 type encoders and decoders). Moreover, the EPO has granted patent rights merely for methods of analyzing networks and producing graphical representations of the networks (for example, see EP2250763B1 (“Arrangements for networks”, Canright et al.), validated in the United Kingdom)(for example, see EP1700421B1 (“A method of managing networks by analyzing connectivity”, Canright et al.), also validated in the United Kingdom), wherein the patent rights have been validated in respect of the UK. Thus, to consider the method of the present disclosure to be subject matter that is excluded from patentability would be totally inconsistent with EPO and UKIPO practice in respect of inventions that are technically closely related to embodiments described in the present disclosure.

The present disclosure also provides a system comprising a server for automatically optimizing a travel itinerary and automatically implementing the travel itinerary, using a machine learning model, comprising:
a first processor;
a memory configured to store data comprising:
   a data obtaining module implemented by the first processor configured to obtain a first set of data;
   a database generating module implemented by the first processor configured to generate a first database from the first set of data;
   a travel option determination module implemented by the first processor configured to determine one or more travel options that are specific to a planned travel by analyzing the first set of data, wherein the machine learning model is generated by a second processor configured to:
      generate a second database with a first set of data associated with travellers,
      generate a third database with a travel itinerary of the travellers,
      process an expert input on the travel itinerary of the travellers, and
      provide (i) the first set of data associated with the travellers, (ii) the travel itinerary of the travellers, and
      (iii) the expert input on the travel itinerary of the travellers, to a machine learning algorithm as training data;
   an itinerary plan request obtaining module implemented by the first processor configured to obtain an itinerary plan request from a user;
   a travel itinerary generation module implemented by the first processor configured to generate a travel itinerary for the itinerary plan request for the user by analyzing the one or more travel options; and
   an automatic travel arrangement module implemented by the first processor configured to implement the travel itinerary by making arrangements for at least one of aircraft, hotel or ground transportation based on the one or more travel options.

The present disclosure also provides a computer program product comprising a non-transitory computer-readable storage medium having computer-readable instructions stored thereon, the computer-readable instructions being executable by a computerized device comprising processing hardware to execute the above method.

Embodiments of the present disclosure substantially eliminate or at least partially address the aforementioned drawbacks in existing approaches for planning travel that can optimize resources and adapt to changing needs of user.

Additional aspects, advantages, features and objects of the present disclosure are made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system in accordance with an embodiment of the present disclosure;

FIG. 2 is a schematic illustration of a system comprising a second processor in accordance with an embodiment of the present disclosure;

FIG. 3 is a functional block diagram of a server in accordance with an embodiment of the present disclosure;

FIG. 4 is an exemplary view of a graphical user interface of a scheduling module in accordance with an embodiment of the present disclosure;

FIG. 5 is an exemplary view of a graphical user interface of a cancellation module in accordance with an embodiment of the present disclosure;

FIG. 6 is an exemplary view of a graphical user interface of a scheduling module in accordance with an embodiment of the present disclosure;

FIG. 7 is a flow diagram that illustrates a method of analyzing a first set of data, using a machine learning model, in accordance with an embodiment of the present disclosure;

FIG. 8 is a flow diagram that illustrates a process of scheduling and itinerary management in accordance with an embodiment of the present disclosure;

FIGS. 9A and 9B are flow charts illustrating a process of automatically optimizing and implementing a travel itinerary in accordance with an embodiment of the present disclosure;

FIG. 10 is a schematic illustration of a system architecture in accordance with an embodiment of the present disclosure;

FIG. 11 is a flow chart illustrating a process of maximizing travel time after a planned customer meeting is cancelled according to an embodiment of the present disclosure;

FIG. 12 is a flow chart illustrating a process for providing destination information associated with a travel itinerary in accordance with an embodiment of the present disclosure; and

FIGS. 13A and 13B are flow diagrams illustrating a method for automatically optimizing a travel itinerary and implementing the travel itinerary for making arrangement, using a machine learning model, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible. For examples, embodiments may be created using software, or using a FPGA(s), or by using an ASIC(s).

The present disclosure provides a method for automatically optimizing a travel itinerary and automatically implementing for the travel itinerary, using a machine learning model executed on a server, the method comprises:
obtaining a first set of data;
generating a first database from the first set of data;
determining, using the machine learning model, one or more travel options that are specific to a planned travel by analyzing the first set of data, wherein the machine learning model is generated by
   generating a second database with a first set of data associated with travellers,
   generating a third database with a travel itinerary of the travellers,
   processing an expert input on the travel itinerary of the travellers, and
   providing (a) the first set of data associated with the travellers, (b) the travel itinerary of the travellers, and (c) the expert input on the travel itinerary of the travellers, to a machine learning algorithm as training data;
obtaining an itinerary plan request from a user;
generating, using the machine learning model, a travel itinerary for the itinerary plan request for the user by analyzing the one or more travel options, and automatically implementing the travel itinerary by making arrangements for at least one of aircraft, hotel or ground transportation based on the one or more travel options.

The present method thus helps to generate a travel itinerary for the itinerary plan request for the user by analyzing the one or more travel options using the machine learning model and automatically making arrangements (e.g. booking tickets, reserving seats, etc.) for at least one of aircraft, hotel or ground transportation. The present method thus enables the user to modify the travel itinerary based on the input of the user by using the machine learning algorithm. The present method generates the travel itinerary for maximizing time for revenue-generating activities and for minimizing transit time while abiding by pre-determined parameters. The present method may help to generate an accurate analysis by comparing the costs and time value of using a company owned aircraft versus a commercial air travel or a charter aircraft and a complexity of the travel itinerary. The present method thus provides a user with fast, reliable data for making decisions about whether to utilize their company aircraft for any travel plan. The present method automatically implements the travel itinerary for making travel arrangements such as booking tickets or reserving seats for at least one of the aircraft, the hotel or the ground transportation, thus eliminates the manual booking and saves time.

It will be appreciated that the aforesaid present method is not merely a “method of doing a mental act”, but has technical effect in that the method functions as a form of technical control using machine learning of a technical artificially intelligent system. The method involves building an artificially intelligent machine learning model and/or using the machine learning model to solve the technical problem of automatically making arrangements making arrangements (e.g. booking tickets, reserving a seat etc.) for at least one of aircraft, hotel or ground transportation for the user's itinerary plan by using the machine learning model.

In an embodiment, multiple travel itineraries may be generated using the present method. The present method prioritizes the generated travel itineraries based on different parameters such as, for example, most effective time working, lowest cost route, most reliable route, the most reliable route. The present method may enable the user to review the travel itineraries and adjust the priority of any of the above parameters in order to display different travel itineraries. The present method may enable the user to decide which travel itinerary to approve and implement for automatic booking of tickets for the travel itinerary. For example, the user may choose a travel itinerary that has highest percentage of reliability if the user feels being at the meeting is more critical than money spent, or a time spent on traveling. In another example, the user may choose a travel itinerary that has a medium cost and have a better average time spent with customer versus a time spent traveling if he wants to spend more time with his customers on a trip, but it's not critical enough to spend three times on travel costs to get twenty percentage more face time with the customer. In an embodiment, the machine learning algorithm predict the user's needs based on his past experience, parameters input during set up and input from user strategic planning sessions, and determines one or more travel options to choose from for the user to achieve an optimal balance between a time spent with customers and cost of travel across different modes of transportation. The purpose of providing one or more travel itinerary, by the machine learning algorithm, to the user is to analyze how different travel itinerary result in real impact through employee time efficacy in relation to money invested and results achieved.

In an embodiment, the travel itinerary is obtained from a user device of the user. The itinerary plan request may be obtained from the user device of the user. The user device may provide the travel itinerary the user. The travel itinerary includes a travel plan with recommendations and an order of travel and a work schedule associated with the user.

The machine learning model may be generated by the server. The first database and/or the second database may be generated by the server. The expert input may be obtained from an expert device. The expert may be a travel advisor or a person who is associated with travel planning or industry.

According to an embodiment, the first set of data comprises at least one of a sales team data, a customer relationship management data comprising a customer data and a customer location information, an aircraft data, a ground transportation data and a price negotiation information.

According to another embodiment, the each of the one or more travel options comprise at least one of a number of hotel nights required, a travel time, cost of travel, an estimated productivity during the travel time, cost of employee's time or luggage requirements.

According to yet another embodiment, the travel itinerary of each traveller comprises a travel plan with recommendations and an order of travel and a work schedule associated with each traveller.

According to yet another embodiment, the itinerary plan request comprises travel plan information selected from at least one of an intended travel time taken from a start to an end of a trip, a date or a time of travel or a mode of travel.

According to yet another embodiment, the travel itinerary that is generated for the user comprises a travel plan and a work schedule for the user, wherein the travel plan comprises a travel time and cost of the travel, information on one or more time slots for meeting customers and recommendations on which sales person should meet which customer and in what order during the travel time to increase the productivity of the user.

According to yet another embodiment, the method comprises enabling the user to review and to provide an input to override the travel itinerary; and modifying the travel itinerary based on the input of the user using the machine learning algorithm.

According to yet another embodiment, the method comprises
providing a primary scheduling interface to enable the user to schedule a call for one or more time slots;
providing on demand modifications to the travel itinerary while the user is on the call to schedule the meetings using the machine learning algorithm;
suggesting an alternate time slot to enable the user to schedule a meeting if a time slot as provided by the travel itinerary is unavailable, using the machine learning algorithm; and
modifying the travel itinerary with the alternate time slot when the user approves that alternate time slot.

According to yet another embodiment, the method further comprises using the machine learning algorithm to determine two or more potential customers within a travel distance based on customer relationship management data, alternate travel options, a travel time and cost for the alternate travel options when a meeting for a time slot has been cancelled at last minute, wherein the alternate travel options are identified based on meetings that are scheduled preceding the cancelled time slot.

According to yet another embodiment, the method comprises
enabling the user to schedule a call with the two or more potential customers to schedule a replacement meeting for the cancelled time slot;
modifying the travel itinerary when a replacement meeting for the cancelled time slot is scheduled using the machine learning algorithm; and
automatically making arrangements when the user approves the replacement meeting.

According to yet another embodiment, the method comprises
enabling the user to override a time slot of the travel itinerary if a customer associated with the cancelled time slot is critical; and
modifying unconfirmed time slots to optimize around the override time slot of the travel itinerary to schedule a meeting with that customer using the machine learning algorithm.

According to yet another embodiment, the method comprises generating the one or more travel options with a balance between a time spent with customers and cost of travel across different modes of transportation.

According to yet another embodiment, the method comprises determining the recommendation of a sales person for meeting a particular customer by matching a sales person to that particular customer using at least one of personality, skill set, expertise, specialization of the sales person or customer data.

According to yet another embodiment, the method comprises providing destination information associated with the travel itinerary to the user for building customer relationships with the customers, wherein the destination information comprises at least one of restaurants that are near to a customer location, weather information of the customer location, attractive places that are near to the customer location.

According to yet another embodiment, the sales team data associated with the user comprises at least one of team strengths, team weaknesses, team dynamics, sales performance history, a time value of a sales person, personal travel preferences, travel policies or individual's time-of-day performance profiles; the customer data associated with the user comprises at least one of sales history, sales projections, challenges or growth factors that affects customer's ability to grow, and the customer location information comprises at least one of specification of airports associated with a customer location or news, hostels, restaurants or weather information pertinent to the customer location; the aircraft data comprises at least one of commercial air routes, a travel time and costs, company aircraft routes or available aircraft charter options; and the ground transportation data comprises at least one of rental car costs, car-for-hire options or a car travel time, wherein the price negotiation information comprises at least one of deals with booking sites or individual providers, or flight planning factors including airport capabilities.

In an embodiment, the present method provides a traveller interface to enable a user (e.g. a traveler or a sales person) to interact with the travel itinerary. The traveller interface may provide an option for the user to execute a block of the travel itinerary. The traveller interface may provide an option to the user to update the travel itinerary with changes, if any, based on the user's travel itinerary. The traveller interface may provide itinerary information such as interactive map and calendar representations of their travel itinerary, planned methods of travel for each leg, applicable tickets/booking information, expected time of travel for each segment, meeting time slots and customer information along with meeting goals and mission critical information to the user. If a company aircraft is being utilized, the traveller interface may provide information on airport arrival times/locations along with any weight restrictions and a name and contact information/messaging options for the aircraft crew involved in the travel itinerary. The traveller interface may provide a customizable to-do list for traveller to utilize as a tool for ensure that they don't leave anything behind when checking out of hotels. In an embodiment, the traveller interface may be provided in a user device of a user (e.g. traveler). The user device may provide a time and a geo-location activated reminder alarm for the to-do lists and critical departure/travel time notifications as well. This helps the user from losing track of time during a meeting, presentation or sales call, causing costly changes to booked travel or initiating a cascading, system-wide delay when utilizing the company aircraft for moving multiple assets around a regional area. The traveller interface may provide a connection to a messaging system for inter-company instant communication. The traveller interface may provide options for logging notes regarding travel experiences or issues experienced, which can be utilized for a continual optimization of a planning process and an execution of the travel itinerary. The traveller interface may provide information on local news and events for each location, so that the user/the traveller is updated and informed on any current events that may affect his travel, the meeting/event, their customer or may utilize that information for building relationship with the customer. The traveller interface may include an “Cancelled Time Block” alarm button for notifying a system and appropriate team members to perform instant action and to attempt re-booking of the cancelled time slot.

The present disclosure provides a system comprising a server for automatically optimizing a travel itinerary and automatically implementing the travel itinerary, using a machine learning model, comprising:
a first processor;
a memory configured to store data comprising:
   a data obtaining module implemented by the first processor configured to obtain a first set of data;
   a database generating module implemented by the first processor configured to generate a first database from the first set of data;
   a travel option determination module implemented by the first processor configured to determine one or more travel options that are specific to a planned travel by analyzing the first set of data, wherein the machine learning model is generated by a second processor configured to:
      generate a second database with a first set of data associated with travellers,
      generate a third database with a travel itinerary of the travellers,
      process an expert input on the travel itinerary of the travellers, and
      provide (i) the first set of data associated with the travellers, (ii) the travel itinerary of the travellers, and (iii) the expert input on the travel itinerary of the travellers, to a machine learning algorithm as training data;
   an itinerary plan request obtaining module implemented by the first processor configured to obtain an itinerary plan request from a user;
   a travel itinerary generation module implemented by the first processor configured to generate a travel itinerary for the itinerary plan request for the user by analyzing the one or more travel options; and
   an automatic travel arrangement module implemented by the first processor configured to implement the travel itinerary by making arrangements for at least one of aircraft, hotel or ground transportation based on the one or more travel options.

The advantages of the present system are thus identical to those disclosed above in connection with the present method and the embodiments listed above in connection with the method apply mutatis mutandis to the system.

The first set of data associated with the user may be obtained from a user device. The first set of data associated with travellers may be obtained from an external server. The itinerary plan request may be obtained from the user device. The server may store at least one of the first database, the second database or the third database. The expert input may be obtained from an expert device.

The one or more travel options that are specific to the planned travel may be provided on the user device. In an embodiment, the user device and the external server are communicatively connected to the server over a communication network. The user device or the external server may comprise a personal computer, a smart phone, a tablet, a laptop or an electronic notebook. The communication network may be a wired network or a wireless network. The server may be a tablet, a desktop, a personal computer or an electronic notebook. In an embodiment, the server may be a cloud service.

The server may partially comprise the above modules to automatically optimizing a travel itinerary and marking arrangements for the travel itinerary. The system may comprise more than one server that may comprise one or more of the above modules. In an embodiment, the server comprises the second processor. The second processor may execute the one or more of the above modules. In another embodiment, the second processor is executed in an external server. The machine learning model may be generated by the first processor. The server may comprise a server database that stores the machine learning model.

According to an embodiment, the system further comprises an itinerary modification module that is configured to
enable the user to review and to provide an input to override the travel itinerary; and
modify the travel itinerary based on the input of the user using the machine learning algorithm.

According to another embodiment, the system further comprises a scheduling module that is configured to
provide a primary scheduling interface to enable the user to schedule a call for one or more time slots;
provide on demand modifications to the travel itinerary while the user is on the call to schedule the meetings using the machine learning algorithm; and
suggest an alternate time slot to enable the user to schedule a meeting if a time slot as provided by the travel itinerary is unavailable, using the machine learning algorithm, wherein itinerary modification module modifies the travel itinerary with the alternate time slot when the user approves that alternate time slot.

According to yet another embodiment, the system further comprises a cancellation module that is configured to determine two or more potential customers within a travel distance based on customer relationship management data, alternate travel options, a travel time and cost for the alternate travel options when a meeting for a time slot has been cancelled at last minute, wherein the alternate travel options are identified based on meetings that are scheduled preceding the cancelled time slot.

According to yet another embodiment, the cancellation module is configured to
enable the user to schedule a call with the two or more potential customers to schedule a replacement meeting for the cancelled time slot;
modify the travel itinerary when a replacement meeting for the cancelled time slot is scheduled using, the machine learning algorithm; and
automatically making arrangements when the user approves the replacement meeting.

According to yet another embodiment, the cancellation module is configured to
enable the user to override a time slot of the travel itinerary if a customer associated with the cancelled time slot is critical; and
modify unconfirmed time slots to optimize around the override time slot of the travel itinerary to schedule a meeting with that customer using the machine learning algorithm.

The present disclosure also provides a computer program product comprising a non-transitory computer-readable storage medium having computer-readable instructions stored thereon, the computer-readable instructions being executable by a computerized device comprising processing hardware to execute the above said method.

The advantages of the present computer program product are thus identical to those disclosed above in connection with the present method and the embodiments listed above in connection with the present method apply mutatis mutandis to the computer program product.

Embodiments of the present disclosure may generate the travel itinerary for the itinerary plan request for the user by analyzing one or more travel options using a machine learning model. Embodiments of the present disclosure may make travel arrangements by automatically booking tickets for at least one of aircraft, hotel or ground transportation, thus eliminates the manual booking of the tickets by the user and saves time. Embodiments of the present disclosure may provide effective maintenance schedules for a company aircraft based on information associated the one or more travel planning process (e.g. travel itinerary) of that company. Embodiments of the present disclosure may ensure safety and regulatory compliance while supporting an extremely high yearly operation time of a company aircraft utilized for travel plans. Embodiments of the present disclosure may help to schedule necessary maintenance to the aircraft when the company aircraft is not in use. Embodiments of the present disclosure may also provide information for identifying when to place their less frequently utilized company aircraft into a charter or a lease program. Embodiments of the present disclosure may help to improve efficiency and minimize conflicts when two or more companies share equity in an aircraft.

### DETAILED DESCRIPTION OF THE DRAWINGS

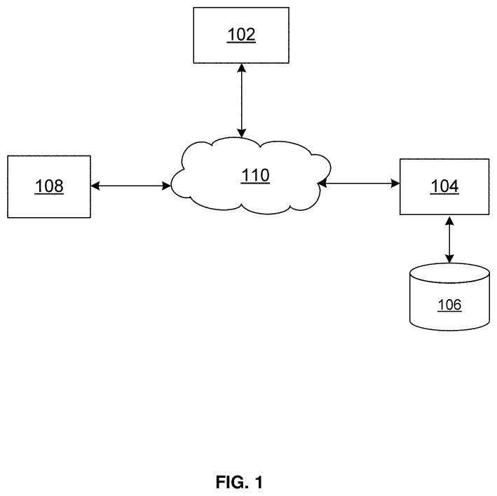

FIG. 1 is a schematic illustration of a system in accordance with an embodiment of the present disclosure. The system comprises a user device 102, a server 104, a server database 106, an external server 108 and a communication network 110. The function of these parts as has been described above.

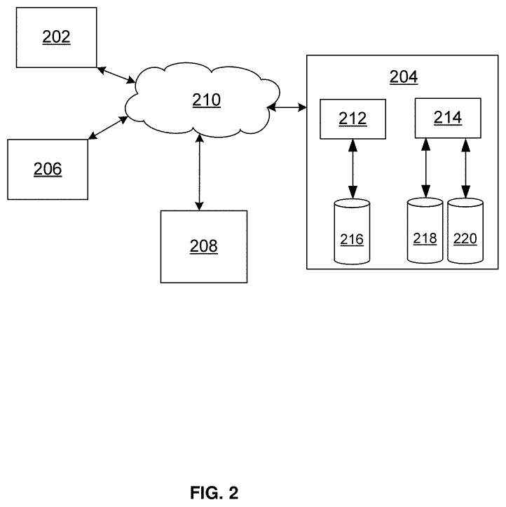

FIG. 2 is a schematic illustration of a system comprising a second processor 214 in accordance with an embodiment of the present disclosure. The system comprises a user device 202, a server 204, an external server 206, an expert device 208 and a communication network 210. The server 204 includes a first processor 212 and a second processor 214. The first processor 212 may generate a first database 216. The second processor 214 may generate a second database 218 and a third database 220. The function of these parts as has been described above.

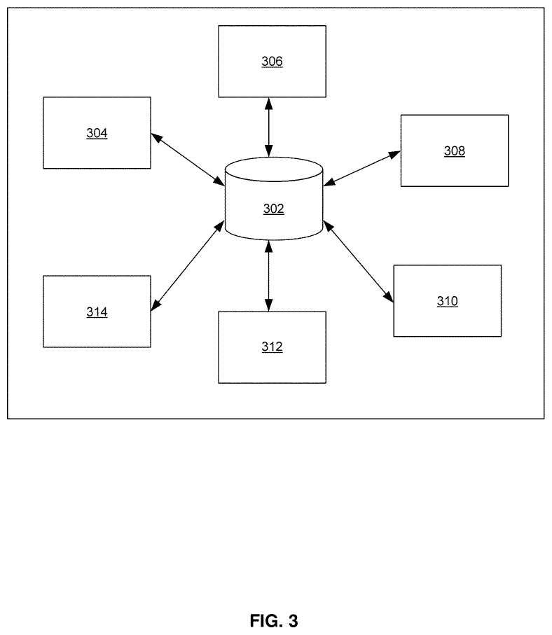

FIG. 3 is a functional block diagram of a server in accordance with an embodiment of the present disclosure. The functional block diagram of the server comprises a server database 302, a data obtaining module 304, a database generating module 306, a travel option determination module 308, an itinerary plan request obtaining module 310, a travel itinerary generation module 312 and an automatic travel arrangement module 314. These modules function as has been described above.

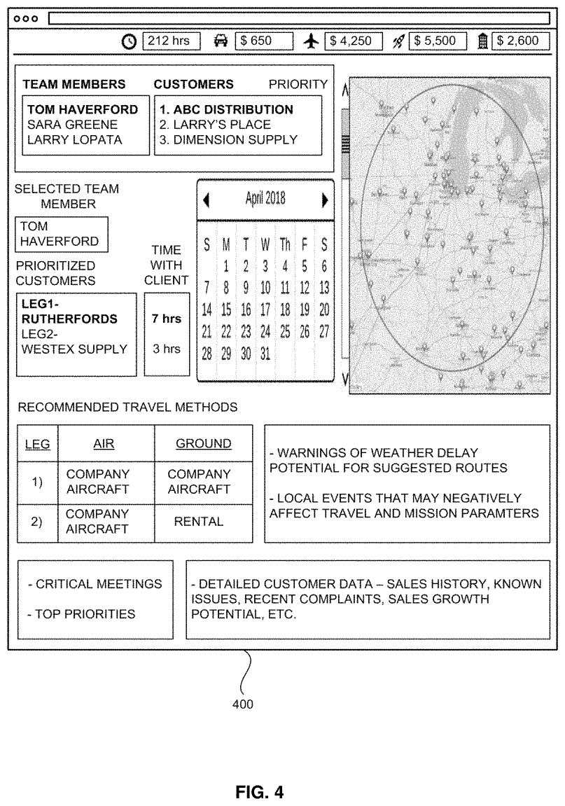

FIG. 4 is an exemplary view of a graphical user interface 400 of a scheduling module in accordance with an embodiment of the present disclosure. The graphical user interface 400 depicts a first set of data associated with an organization. The first set of data may comprise a map, team member lists, relevant performance data and other factors critical to a planning process, selected team member, prioritized users, user's location, office or factory location, event location etc. The graphical user interface 400 may allow an executive, assistant, a sales manager or any team within an organization to easily access all data relevant to a travel planning process. The graphical user interface 400 may further show recommendations that comprises data about a salesperson who can attend the customer and a time slot for attending the customer by that salesperson. The graphical user interface 400 may allow re-ordering of every element involved in a travel itinerary with an immediate feedback as to how changes can affect the entire travel itinerary, including a total time actually spent engaging in value-generating activities, costing variables and a total time that a traveller has available to work his tasks versus a time spent in non-productive environments during a trip. The graphical user interface 400 may provide one or more travel routes selected for a time period for quick, easy visual reference to be made to the travel itinerary that is being built. The graphical user interface 400 may provide options to scale and modify the first set of data and to display individual elements of the travel itinerary for clicking and expanding for accessing details specific to each element of the travel itinerary.

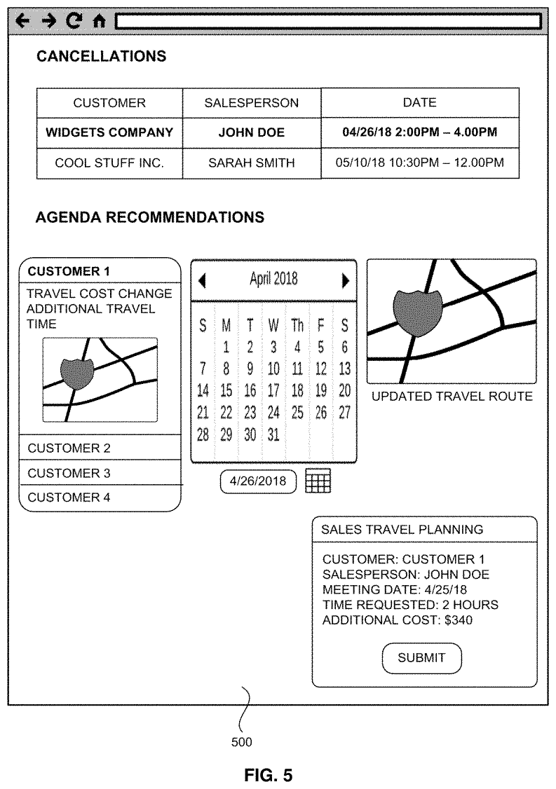

FIG. 5 is an exemplary view of a graphical user interface 500 of a cancellation module in accordance with an embodiment of the present disclosure. The graphical user interface 500 depicts cancellation information that includes a name of a user, a name of a sales person and a date of cancellation, agenda recommendations that includes a change in travel cost, an additional travel time required, an updated travel route and a sales travel planning (e.g. customer, sales person, meeting date, time requested and additional cost). The graphical user interface 500 may provide the cancellation information that are critical to a rapid response to last minute cancellations during a trip. The graphical user interface 500 may provide an interface for managing responses to the cancellations. When a meeting scheduled for a time slot is cancelled, the cancellation module may automatically identify potential customers or valuable activities that can be performed through one or more travel options within a time frame. The cancellation module may utilize all pertinent data to determine opportunities that are of highest priority and makes recommendations accordingly. The cancellation module calculates costs and a time value of adjustments to the travel itinerary and displays the information in real time in order to properly weighed against an opportunity being addressed. The graphical user interface 500 may provide contact information of the potential customers and provide an option to dial directly from the interface 500. When a replacement meeting is confirmed for the time slot that is cancelled at last minute, one or more travel options are automatically booked/altered through the graphical user interface 500 upon approval. The graphical user interface 500 may provide warnings if a company travel policy is being violated by the travel itinerary and provide connections for receiving manager approval or manager override on the travel itinerary as needed.

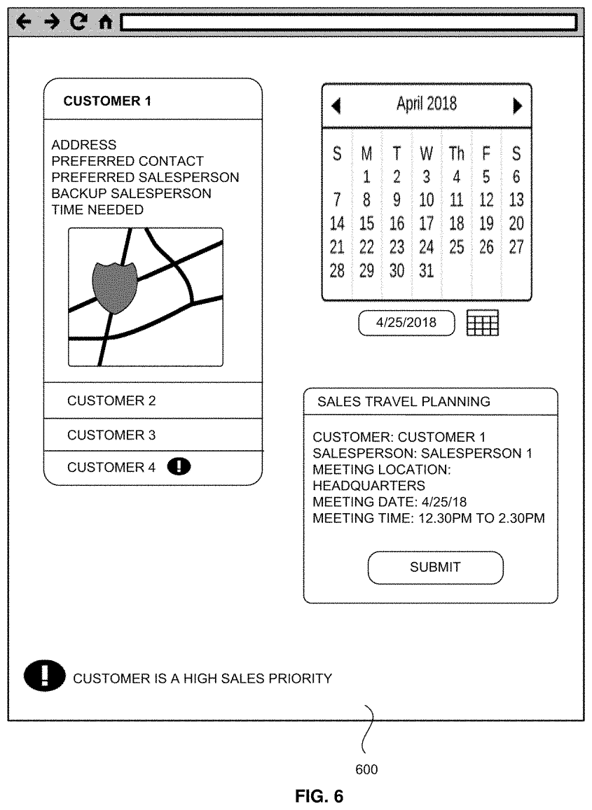

FIG. 6 is an exemplary view of a graphical user interface 600 of a scheduling module in accordance with an embodiment of the present disclosure. The graphical user interface 600 depicts scheduled calls information that includes an address of a customer, a preferred contact, a preferred salesperson to meet the customer, a backup salesperson and a travel time needed, a date and sales travel planning. The graphical user interface 600 may provide an option to execute phone calls necessary for booking meetings according to a travel itinerary generated by a user using a planning interface. The graphical user interface 600 may provide customer service call centre (e.g. sales person, executive, etc.) with both a primary time slot in which a meeting can be booked and a multiple back-up time slots if a customer is unavailable for the primary time slot. The graphical user interface 600 may display booked calls in order of priority as determined during a planning process. The graphical user interface 600 may provide necessary information to the user to make the calls. Once calls are booked and entered into the graphical user interface 600, the graphical user interface 600 may display real-time adjustments to time slot prioritization for the remaining travel itinerary based on which booking options may be locked. The graphical user interface 600 may provide an option to the user to override the travel itinerary when a customer who is critical during a planning process is not available for a time slot as provided by the travel itinerary. The graphical user interface 600 may provide quick communication links for getting immediate input from the user who involved in each booking or for getting manager approval for overriding the travel itinerary. The graphical user interface 600 may provide the customer service call center with information on one or more time slots being booked/scheduled and provide warnings when a potential conflict or violation of a company travel policy arise.

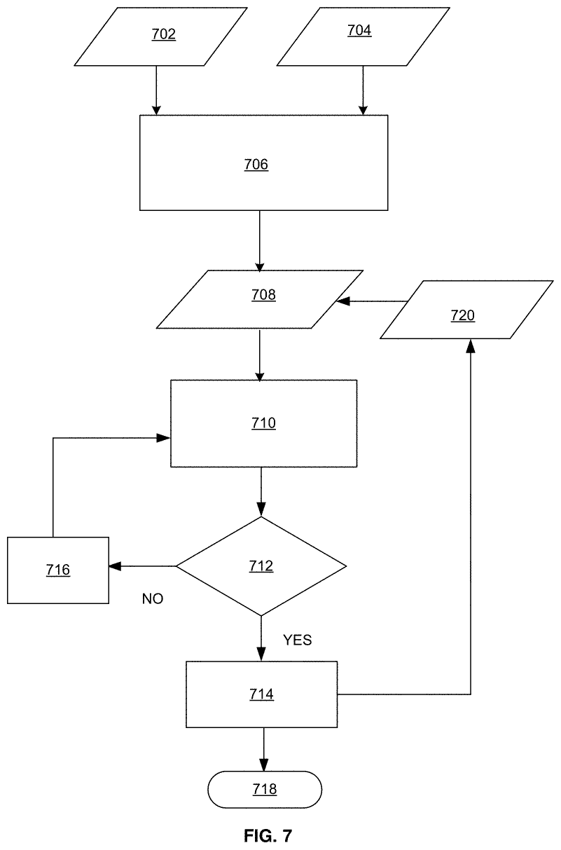

FIG. 7 is a flow diagram that illustrates a method of analyzing a first set of data, using a machine learning model, in accordance with an embodiment of the present disclosure. At step 702, one or more travel options such as hotel and rental car data, charter data, company's aircraft and commercial airline data are obtained. At step 704, customer data such as individual preferences, travel policy and customer relationship management data are obtained. At step 706, the one or more travel options are combined with the customer data to obtain a continual predictive optimization of team travel options that are specific to a planned travel. At step 708, an itinerary plan request is obtained from a user. At step 710, the travel itinerary that is generated for the user using the machine learning model. The travel itinerary comprises a travel plan and a work schedule for the user. At step 712, it is checking whether the travel itinerary meets the itinerary plan request obtained from the user. If YES go to step 714 else go to step 716. At step 714, tickets for at least one of aircraft, hotel or ground transportation are automatically booked. At step 716, the travel itinerary is modified based on an input of the user and an updated travel itinerary is generated based on the input of user using the machine learning model. At step 718, necessary data and the tickets are communicated to the user via a cloud-based web portal or a device-based application. At step 720, the travel itinerary and travel cost data are updated with customer relationship management data.

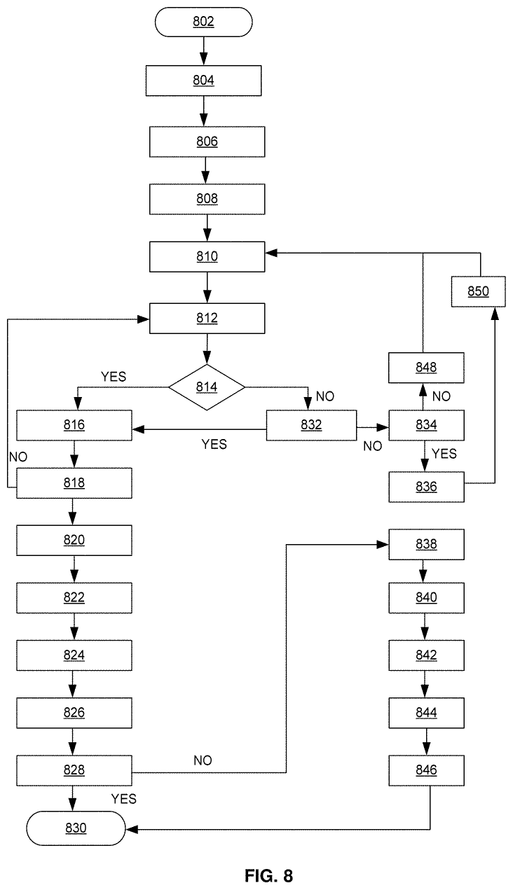

FIG. 8 is a flow diagram that illustrates a process of scheduling and itinerary management in accordance with an embodiment of the present disclosure. At step 802, a travel itinerary for a time period is requested. At step 804, a travel itinerary that is generated using a machine learning model for the requested time period is analyzed. At step 806, modifications are made to the travel itinerary based on an input from a user. At step 808, the travel itinerary is modified based on the input of the user using the machine learning algorithm. At step 810, an updated travel itinerary is generated. At step 812, a primary scheduling interface is provided to enable the user to schedule a call for one or more time slots as provided by the updated travel itinerary. At step 814, it is checking whether a customer is available for a time slot as provided by the travel itinerary. If YES go to step 816 else go to step 832. At step 816, the time slot is locked when the customer is available. At step 818, it is checking whether the one or more time slots as provided by the updated travel itinerary are booked. If YES go to step 820 else go to step 812. At step 820, a final computation of optimum travel itinerary is performed. At step 822, the optimized travel itinerary is approved by a manager. At step 824, tickets are automatically booked for at least one of an aircraft, hotel or ground transportation based on the optimized travel itinerary. At step 826, the optimized travel itinerary is uploaded to a flight department. At step 828, it is checking whether meeting scheduled for the one or more time slots are showing. If YES go to step 830 else go to step 838. At step 830, the travel itinerary is successfully executed. At step 832, it is checking whether an alternate time slot suggested by the machine learning model works for the customer who is unavailable. If YES go to step 816 else go to step 834. At step 834, it is checking whether a time spending with a customer is critical for the time period being planned. If YES go to step 836 else go to step 848. At step 836, the travel itinerary is override for the time slot as that customer is critical. At step 838, a meeting for a time slot that is cancelled is notified by the user through an application. At step 840, one or more potential customers to visit in area, travel options, travel options, travel time and costs are determined by using the machine learning algorithm for the cancelled time slot. At step 842, the scheduling interface is provided to enable the user to schedule a call with the two or more potential customers to schedule a replacement meeting for the cancelled time slot when the manager approves the one or more potential customers. At step 844, the optimal travel itinerary is calculated by using the machine learning model when the replacement meeting is scheduled at last minute. At step 846, the travel itinerary is booked automatically or the aircraft is deployed upon the manager approval. At step 848, the customers are prioritized for next travel and an alternate time slot is provided using the machine learning model and the new travel itinerary is generated at 810. At step 850, unconfirmed time slots are modified to optimize around the override time slot of the travel itinerary to schedule a meeting with that customer using the machine learning algorithm and the new travel itinerary is generated at 810. In an embodiment, the travel itinerary and tickets are managed by the user through an application or web interface when the tickets are automatically book at step 824.

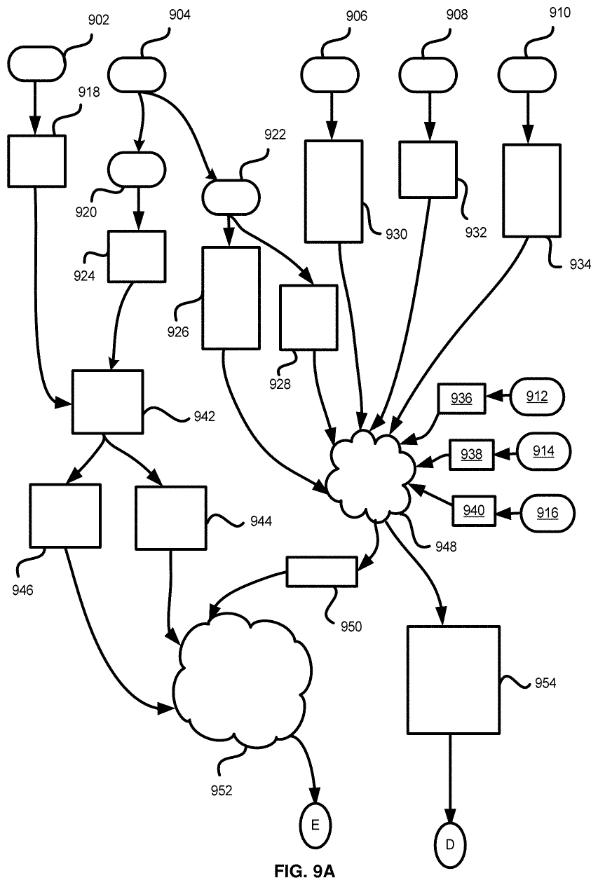

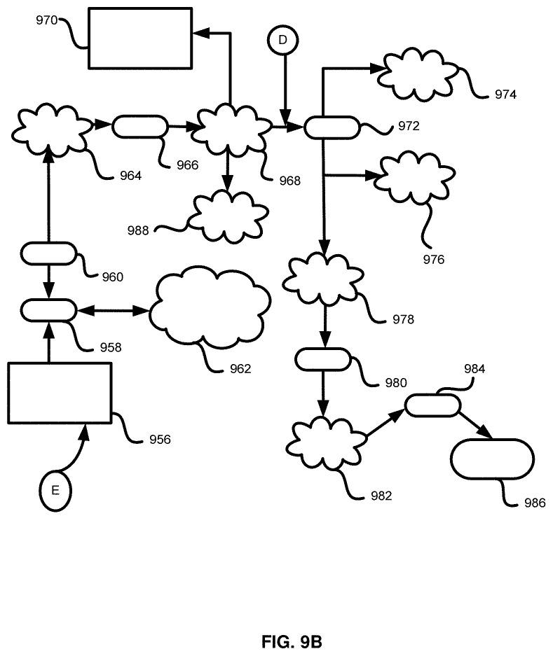

FIGS. 9A and 9B are flow charts illustrating a process of automatically optimizing and implementing a travel itinerary in accordance with an embodiment of the present disclosure. At step 902, a sales team data is obtained. At step 904, a customer relationship management data is obtained. At step 906, a company aircraft data is obtained. At step 908, a flight planning data is obtained. At step 910, a commercial air travel data is obtained. At step 912, a jet charter data is obtained. At step 914, a ground transportation data is obtained. At step 916, a price negotiation data is obtained. At step 918, the sales team data such as time value of team member, personality profiles, strength and weaknesses, areas of expertise, endurance profiles, a sales performance history, personal travel preferences, a travel policy, health issues and small aircraft comfort, optimum performance time profiles, compensation considerations, team dynamics, team synergies etc. are provided to a server. At step 920, a customer data is obtained from from the data customer relationship management data. At step 922, a customer location information is obtained from the data customer relationship management data. At step 924, the customer data such as customer relationship management data integration, personalities, sales history, known challenges and growth factors that includes a market size, capabilities, a technology, commitment, competition etc. are provided to the server. At step 926, the customer location information such as airport specifications that include runways, procedures, operation hours, pilot's facilities, a quality of services, rental/crew car, ramp-side car pickup, fuel that includes hours, price, full or self and minimum, parking fees, overnight fees, restrictions, Notable issues that include hazardous geography, altitude, weather/wind, night time hazards etc. are provided to the server. At step 928, the customer location information such as city data that includes hotel information, restaurant information, seasonal traffic, weather information, local attractions, sports team information, notable points of pride, top news stories etc. are provided to the server. At step 930, the company aircraft data such as passenger or cargo configurations, range, a speed and climb for all profiles, economy profiles, weather capabilities, safety systems, runway capabilities for every profile, maintenance tracking, downtime planning, crew considerations etc. are provided to the server. At step 932, the flight planning data such as travel time that includes driving time, weather that includes current and predictive, Notice to Airmen (NOTAMS) and pilot reports (PIREPS) and third-party application programming interface (API) etc. are provided to the server. At step 934, the commercial air travel data such as price, a travel time that includes drive time and terminal time, on-time performance, wireless fidelity (WIFI) availability, seasonal volume, airport arrival time variables (e.g. 1 hour for smaller airports and up to 2.5 hours for larger airports), departure and arrival time options, transfers, baggage cost and limitations, loyalty programs etc. are provided to the server. At step 936, the jet charter data such as a price and a travel time that includes drive time are provided to the server. At step 938, the ground transportation data such as rental options that includes fast track, hotel or terminal, shuttle time and loyalty programs, ride share options, car service options, planeside service at fixed-base operator (FBO) etc. are provided to the server. At step 940, the price negotiation data such as deals with booking sites, deals with individual providers, partnership with existing Travel Management Company (TMC), FBO fleet fuel pricing, aircraft maintenance volume pricing, flight planning software enterprise pricing, pilot training pricing etc. are provided to the server. At step 942, the sales team is optimised. At step 944, the sales person is matched to a customer using his personality, skill set, expertise, specialization, customer data, etc. At step 946, power teams are created to identify synergies based on the customer data and the sales team data. At step 948, the server determines, using a machine learning algorithm, one or more travel options that are specific to a planned travel by analysing the above data with a balance between a time spent with customers and cost of travel across different modes of transportation that includes a number of hotel nights required, a travel time, a cost of travel, an estimated productivity during the travel time, cost of employee's time or luggage requirements, etc. At step 950, the server provides the one or more travel options. At step 952, the server analyses company goals, a travel policy, the team information, the customer information and the one or more travel options to generate travel itineraries, using the machine learning algorithm, based on an itinerary plan request from a user for asset deployment strategies with highest probability of achieving target Return on investment (ROI) of time and resources. At step 954, the server provides destination information associated with the travel itinerary to the user for building customer relationships with the customers. The destination information comprises at least one of restaurants that are near to a customer location, weather information of the customer location, attractive places that are near to the customer location. At step 956, team members/managers review the travel itineraries provided by the server and select a travel itinerary to implement. At step 958, the server provides a primary scheduling interface to enable the user to schedule a call with customers for one or more time slots. At step 960, the travel itinerary is modified based on the input of the user using the machine learning algorithm. At step 962, the server provides on demand modifications to the travel itinerary while the user is on call with the customers to schedule the meetings, using the machine learning algorithm, and suggests an alternate time slot to enable the user for scheduling a meeting if a customer is not available for a time slot as provided by the travel itinerary using the machine learning algorithm. At step 964, the server modifies the travel itinerary with the alternate time slot when the user approves that alternate time slot using the machine learning algorithm. At step 966, the modified travel itinerary is provided to the user for approval. At step 968, the server automatically books the tickets when the user approves the replacement meeting. At step 970, the travel costs information is automatically transferred to an accounting software of the company. At step 972, the travel itinerary is provided to an application of a user device of the user or a cloud service. At step 974, the server enables automatic check-in for commercial segments. At step 976, the server automates the flight planning. At step 978, the server monitors a location of team member locations. At step 980, information of a meeting for a time slot that has been cancelled at last minute is identified by the server. At step 982, the server determines two or more potential customers within a travel distance for the cancelled meeting based on the customer relationship management data, alternate travel options, a travel time and cost for the alternate travel options. The alternate travel options are identified based on meetings that are scheduled preceding the cancelled time slot. At step 984, the server provides the primary scheduling interface to enable the user to schedule a call with two or more potential customers for the cancelled time slot. At step 986, the ground/commercial travel tickets are automatically booked by the server. At step 988, a hotel and ground transport tickets are automatically booked by the server.

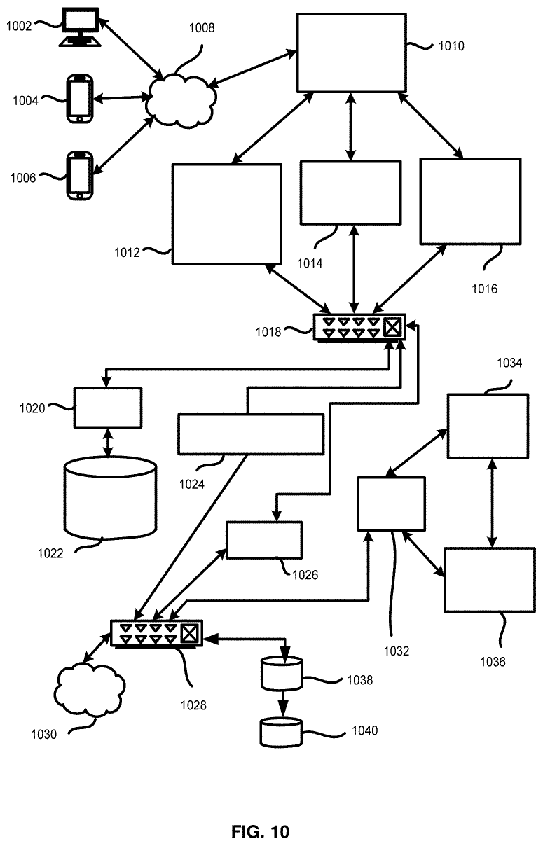

FIG. 10 is a schematic illustration of a system architecture in accordance with an embodiment of the present disclosure. The system includes a client management device 1002, a user device 1004 comprising a sales application, a flight crew application device 1006, a first wireless arear network (WAN) 1008, a firewall router 1010, a management interface server cluster 1012, a user web server cluster 1014, a flight crew web server cluster 1016, a first switch 1018, a load balancer 1020, a relational database 1022, an infrastructure monitoring server 1024, a cluster 1026, a second switch 1028, a second WAN 1030, a configuration server 1032, a query router 1034, a database shards 1036, a primary database 1038 and a secondary database 1040.

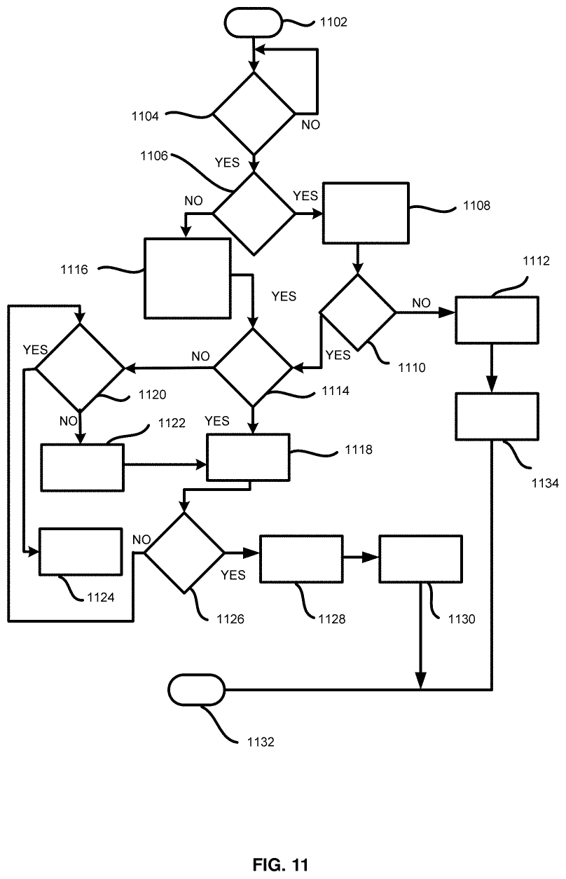

FIG. 11 is a flow chart illustrating a process of maximizing travel time after a planned customer meeting is cancelled according to an embodiment of the present disclosure. At step 1102, the process is started. At step 1104, it is checking whether a notification for a cancelled meeting is received. If YES go to step 1106 else, it is checking again whether a notification for the cancelled meeting is received. At step 1106, it is checking whether a time slot for the cancelled meeting is on same work day. If YES go to step 1108 else go to step 1116. At step 1108, a call list is modified based on remaining time in the work day and travel time restrictions. At step 1110, it is checking whether potential customers are available within a travel distance considering the time restrictions and the travel options. If YES go to step 1114 else go to step 1112. At step 1112, it is reported to a user (e.g. a traveller) when no alternate travel option exists, or no potential customer is available within the travel distance. At step 1114, it is checking whether travel options are approved by a manager for scheduling a meeting with the potential customer. If YES go to step 1118 else go to step 1120. At step 1118, a new call list is sent to the user to make calls for scheduling a meeting with the potential customer. At step 1120, it is checking whether the manager wants the cancelled time slot to be unscheduled. If YES go to step 1124 else go to step 1122. At step 1122, the travel itinerary is manually overridden with the manager's plan and an updated call list is sent to the user to schedule calls with customers as per the manager's plan at step 1118. At step 1124, it is reported to the user that the manager wants the cancelled time slot to be unscheduled. At step 1126, it is checking whether a customer from the updated call list is available for meeting. If YES go to step 1128 else go to step 1120. At step 1128, a replacement meeting details for the cancelled time slot is updated. At step 1130, all necessary parties such as the user or the traveller, the manager, aircraft crew are notified of change in the travel itinerary and necessary arrangements such as ticket booking etc. are automatically made for the replacement meeting. At step 1132, the travel itinerary is executed. At step 1134, it is reported to a sales manager that the meeting is cancelled if no alternate travel option exists at step 1112.

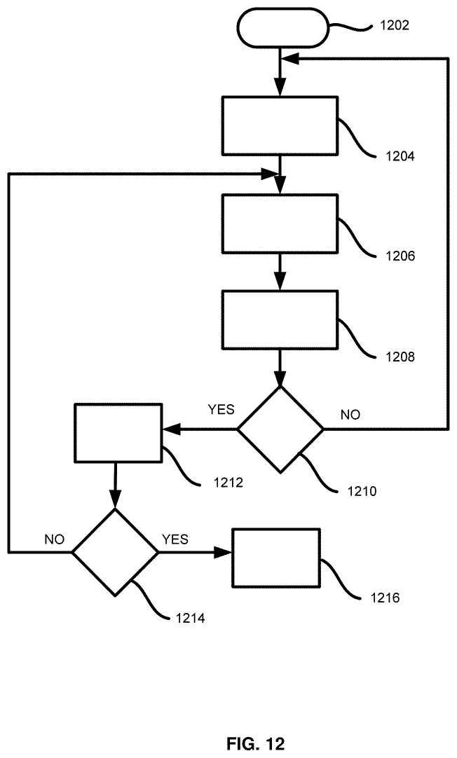

FIG. 12 is a flow chart illustrating a process for providing destination information associated with a travel itinerary in accordance with an embodiment of the present disclosure. At step 1202, the process is started. At step 1204, a user's (e.g. a sales person) next travel destinations are retrieved form a travel itinerary of the user. At step 1206, one or more databases are analysed to generate personalised customer and local information for a customer based on location information of the customer. At step 1208, personalised customer and local information (e.g. news feed and activity options to a sales application of the user) are provided to the user. At step 1210, it is checking whether a local dining, or any activity is suggested for the customer. If YES go to step 1212 else go to step 1204. At step 1212, the scheduled suggestion is automatically deployed and an invite for the suggestion is sent to the customer. At step 1214, it is checking whether the customer accepts the invite. If YES go to step 1216 else go to step 1206. At step 1216, the scheduling suggestion are added to a calendar and a booking interface of the user.

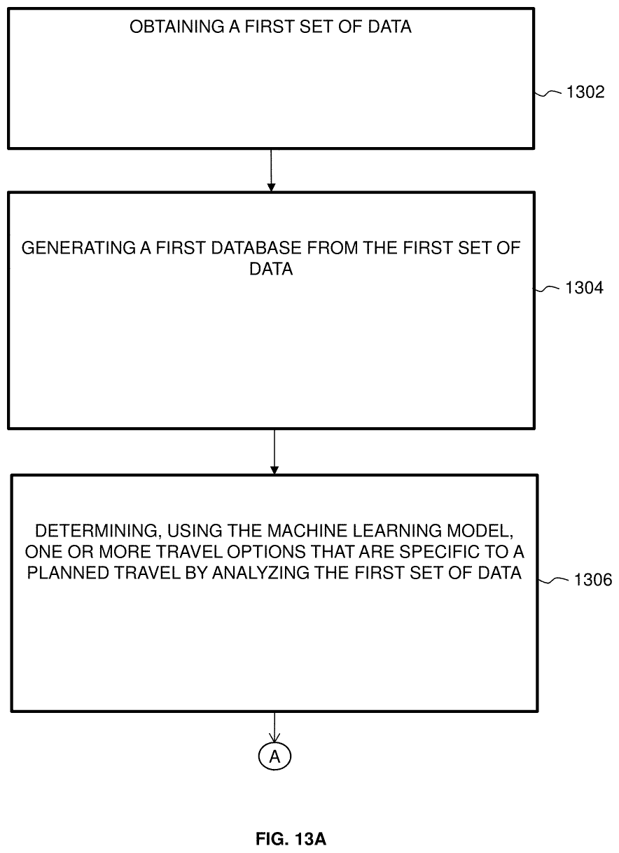

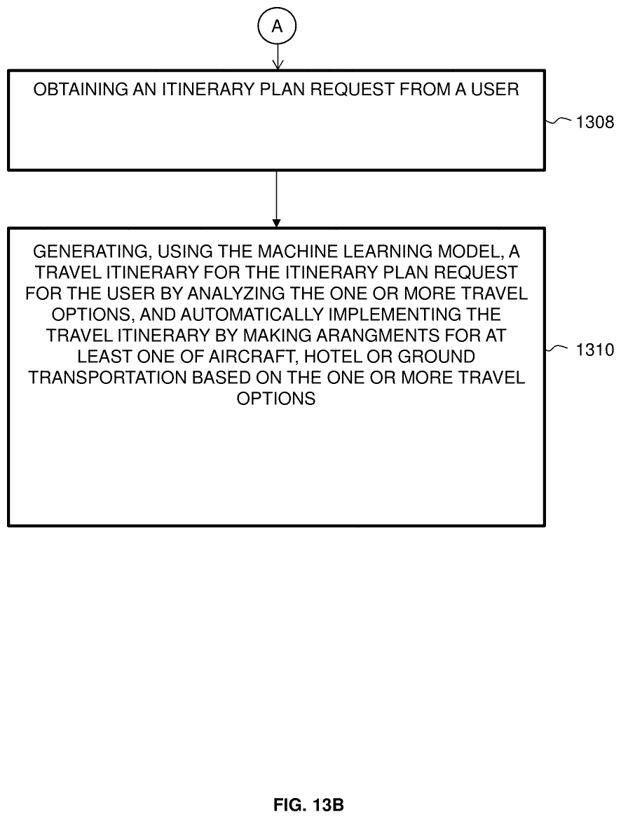

FIGS. 13A and 13B are flow diagrams illustrating a method for automatically optimizing a travel itinerary and implementing the travel itinerary for making arrangement, using a machine learning model, in accordance with an embodiment of the present disclosure. At step 1302, a first set of data is obtained. At step 1304, a first database is generated from the first set of data. At step 1306, one or more travel options that are specific to a planned travel are determined by analyzing the first set of data using the machine learning model. At step 1308, an itinerary plan request is obtained from a user. At step 1310, a travel itinerary for the itinerary plan request for the user is generated by analyzing the one or more travel options and the travel itinerary is automatically implemented by making arrangement for at least one of aircraft, hotel or ground transportation based on the one or more travel options.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for automatically optimizing a travel itinerary and automatically implementing for the travel itinerary, using a machine learning model executed on a server, the method comprises:
obtaining a first set of data;
generating a first database from the first set of data;
determining, using the machine learning model, one or more travel options that are specific to a planned travel by analyzing the first set of data, wherein the machine learning model is generated by
generating a second database with a first set of data associated with travellers,
generating a third database with a travel itinerary of the travellers,
processing an expert input on the travel itinerary of the travellers, and
providing (a) the first set of data associated with the travellers, (b) the travel itinerary of the travellers, and (c) the expert input on the travel itinerary of the travellers, to a machine learning algorithm as training data;
obtaining an itinerary plan request from a user;
generating, using the machine learning model, a travel itinerary for the itinerary plan request for the user by analyzing the one or more travel options, and automatically implementing the travel itinerary by making arrangements for at least one of aircraft, hotel or ground transportation based on the one or more travel options.

2. A method according to claim 1, wherein the first set of data comprises at least one of a sales team data, a customer relationship management data comprising a customer data and a customer location information, an aircraft data, a ground transportation data and a price negotiation information.

3. A method according to claim 1, wherein the each of the one or more travel options comprise at least one of a number of hotel nights required, a travel time, cost of travel, an estimated productivity during the travel time, cost of employee's time or luggage requirements.

4. A method according to claim 1, wherein the travel itinerary of each traveller comprises a travel plan with recommendations and an order of travel and a work schedule associated with each traveller.

5. A method according to claim 1, wherein the itinerary plan request comprises travel plan information selected from at least one of an intended travel time taken from a start to an end of a trip, a date or a time of travel or a mode of travel.

6. A method according to claim 1, wherein the travel itinerary that is generated for the user comprises a travel plan and a work schedule for the user, wherein the travel plan comprises a travel time and cost of the travel, information on one or more time slots for meeting customers and recommendations on which sales person should meet which customer and in what order during the travel time to increase the productivity of the user.

7. A method according to claim 1, further comprising
enabling the user to review and to provide an input to override the travel itinerary; and
modifying the travel itinerary based on the input of the user using the machine learning algorithm.

8. A method according to claim 1, method further comprising:
providing a primary scheduling interface to enable the user to schedule a call for one or more time slots;
providing on demand modifications to the travel itinerary while the user is on the call to schedule the meetings using the machine learning algorithm;
suggesting an alternate time slot to enable the user to schedule a meeting if a time slot as provided by the travel itinerary is unavailable, using the machine learning algorithm; and
modifying the travel itinerary with the alternate time slot when the user approves that alternate time slot.

9. A method according to claim 1, wherein the method further comprises using the machine learning algorithm to determine two or more potential customers within a travel distance based on customer relationship management data, alternate travel options, a travel time and cost for the alternate travel options when a meeting for a time slot has been cancelled at last minute, wherein the alternate travel options are identified based on meetings that are scheduled preceding the cancelled time slot.

10. A method according to claim 9, further comprising
enabling the user to schedule a call with the two or more potential customers to schedule a replacement meeting for the cancelled time slot;
modifying the travel itinerary when a replacement meeting for the cancelled time slot is scheduled using the machine learning algorithm; and
automatically making arrangements when the user approves the replacement meeting.

11. A method according to claim 9, further comprising
enabling the user to override a time slot of the travel itinerary if a customer associated with the cancelled time slot is critical; and
modifying unconfirmed time slots to optimize around the override time slot of the travel itinerary to schedule a meeting with that customer using the machine learning algorithm.

12. A method according to claim 1, further comprising generating the one or more travel options with a balance between a time spent with customers and cost of travel across different modes of transportation.

13. A method according to claim 6, further comprising determining the recommendation of a sales person for meeting a particular customer by matching a sales person to that particular customer using at least one of personality, skill set, expertise, specialization of the sales person or customer data.

14. A method according to claim 1, wherein the method comprises providing destination information associated with the travel itinerary to the user for building customer relationships with the customers, wherein the destination information comprises at least one of restaurants that are near to a customer location, weather information of the customer location, attractive places that are near to the customer location.

15. A method according to claim 2, wherein
the sales team data associated with the user comprises at least one of team strengths, team weaknesses, team dynamics, sales performance history, a time value of a sales person, personal travel preferences, travel policies or individual's time-of-day performance profiles,
the customer data associated with the user comprises at least one of sales history, sales projections, challenges or growth factors that affects customer's ability to grow, and the customer location information comprises at least one of specification of airports associated with a customer location or news, hostels, restaurants or weather information pertinent to the customer location,
the aircraft data comprises at least one of commercial air routes, a travel time and costs, company aircraft routes or available aircraft charter options, and
the ground transportation data comprises at least one of rental car costs, car-for-hire options or a car travel time, wherein the price negotiation information comprises at least one of deals with booking sites or individual providers, or flight planning factors including airport capabilities.

16. A system comprising a server for automatically optimizing a travel itinerary and automatically implementing the travel itinerary, using a machine learning model, comprising:
a first processor;
a memory configured to store data comprising:
a data obtaining module implemented by the first processor configured to obtain a first set of data;
a database generating module implemented by the first processor configured to generate a first database from the first set of data;
a travel option determination module implemented by the first processor configured to determine one or more travel options that are specific to a planned travel by analyzing the first set of data, wherein the machine learning model is generated by a second processor configured to:
generate a second database with a first set of data associated with travellers,
generate a third database with a travel itinerary of the travellers,
process an expert input on the travel itinerary of the travellers, and
provide (i) the first set of data associated with the travellers, (ii) the travel itinerary of the travellers, and (iii) the expert input on the travel itinerary of the travellers, to a machine learning algorithm as training data;
an itinerary plan request obtaining module implemented by the first processor configured to obtain an itinerary plan request from a user;
a travel itinerary generation module implemented by the first processor configured to generate a travel itinerary for the itinerary plan request for the user by analyzing the one or more travel options; and
an automatic travel arrangement module implemented by the first processor configured to implement the travel itinerary by making arrangements for at least one of aircraft, hotel or ground transportation based on the one or more travel options.

17. A system according to claim 16, wherein the system further comprises an itinerary modification module that is configured to
enable the user to review and to provide an input to override the travel itinerary; and
modify the travel itinerary based on the input of the user using the machine learning algorithm.

18. A system according to claim 16, wherein the system further comprises a scheduling module that is configured to
provide a primary scheduling interface to enable the user to schedule a call for one or more time slots;
provide on demand modifications to the travel itinerary while the user is on the call to schedule the meetings using the machine learning algorithm; and
suggest an alternate time slot to enable the user to schedule a meeting if a time slot as provided by the travel itinerary is unavailable, using the machine learning algorithm, wherein itinerary modification module modifies the travel itinerary with the alternate time slot when the user approves that alternate time slot.

19. A system according to claim 16, wherein the system further comprises a cancellation module that is configured to determine two or more potential customers within a travel distance based on customer relationship management data, alternate travel options, a travel time and cost for the alternate travel options when a meeting for a time slot has been cancelled at last minute, wherein the alternate travel options are identified based on meetings that are scheduled preceding the cancelled time slot.

20. A system according to claim 19, wherein the cancellation module is configured to enable the user to schedule a call with the two or more potential customers;
modify the travel itinerary when a replacement meeting for the cancelled time slot is scheduled using the machine learning algorithm; and
automatically book the tickets when the user approves the replacement meeting.

21. A system according to claim 19, wherein the cancellation module is configured to
enable the user to override a time slot of the travel itinerary if a customer associated with the cancelled time slot is critical; and
modify unconfirmed time slots to optimize around the override time slot of the travel itinerary to schedule a meeting with that customer using the machine learning algorithm.

22. A computer program product comprising a non-transitory computer-readable storage medium having computer-readable instructions stored thereon, the computer-readable instructions being executable by a computerized device comprising processing hardware to execute a method as claimed in claim 1.
